(19) United States
(12) Patent Application Publication
(10) Pub. No.: US 2026/0370799 A1
(43) Pub. Date: Nov. 19, 2026

(54) IMAGE SENSING DEVICE

(71) Applicant: SK hynix Inc., Icheon-si (KR)

(72) Inventor: Hyun Min SONG, Icheon-si (KR)

(21) Appl. No.: 19/357,355

(22) Filed: Oct. 14, 2025

(30) Foreign Application Priority Data
May 16, 2025 (KR) 10-2025-0063754

(51) Int. Cl. H04N 17/00; H04N 25/709; H04N 25/77

(52) U.S. Cl. CPC H04N 17/002; H04N 25/709; H04N 25/77

(57) ABSTRACT

Image sensing devices are disclosed. In an embodiment, an image sensing device includes a plurality of pixels, each of the plurality of pixels including a photodetector configured to convert incident light into an electrical signal; a separation structure surrounding each of the plurality of pixels; a bias conductive structure disposed inside the separation structure and insulated from the photodetector by the separation structure; and a deterioration detection circuit electrically connected to the bias conductive structure and configured to detect a leakage current flowing in the bias conductive structure in response to a negative bias voltage applied to the deterioration detection circuit, wherein the deterioration detection circuit includes a resistor portion including one end electrically connected to the bias conductive structure; and a switching element configured to turn off in response to a voltage drop occurring across the resistor portion.

### PRIORITY CLAIM AND CROSS REFERENCE TO RELATED APPLICATION

This patent document claims the priority and benefits of Korean Patent Application No. 10-2025-0063754, filed on May. 16, 2025, the disclosure of which is incorporated herein by reference in its entirety.

### TECHNICAL FIELD

Embodiments of the disclosed technology relate to an image sensing device.

### BACKGROUND

With the development of information and communication technologies and the digitalization of electronic devices, high-performance image sensors are increasingly being used in various applications, such as digital cameras, camcorders, mobile phones, personal communication systems (PCS), game devices, security cameras, and medical micro cameras.

In general, an image sensor includes a pixel area that includes a photodetector such as a photodiode, and a peripheral circuit area. A unit pixel includes a photodiode and a transistor. The transistor is placed between the photodiode and a floating diffusion region to transfer charges generated by the photodiode to the floating diffusion region.

### SUMMARY

Embodiments of the disclosed technology provide an image sensing device that may determine whether a die (semiconductor die) is normal through electrical parameter monitoring (EPM) testing without requiring additional equipment.

In an embodiment of the disclosed technology, an image sensing device based on an embodiment may include a plurality of pixels, each of the plurality of pixels including a photodetector configured to convert incident light into an electrical signal; a separation structure surrounding each of the plurality of pixels; a bias conductive structure disposed inside the separation structure and insulated from the photodetector by the separation structure; and a deterioration detection circuit connected to the bias conductive structure and configured to detect a leakage current flowing in the bias conductive structure in response to a negative bias voltage applied to the deterioration detection circuit. The deterioration detection circuit may include a resistor portion including one end electrically connected to the bias; and a switching element configured to turn off in response to a voltage drop occurring across the resistor portion.

In another embodiment, an image sensing device may include a plurality of pixels, each of the plurality of pixels including a photodetector configured to convert incident light into an electrical signal; a separation structure surrounding each of the plurality of pixels; a bias conductive structure disposed inside the separation structure and insulated from the photodetector by the separation structure; and a deterioration detection circuit electrically connected to the bias conductive structure and configured to detect a leakage current flowing in the bias conductive structure in response to receiving a power supply voltage, a bias voltage, and a bias enable signal. The power supply voltage may have a first voltage level, the bias voltage may have a second voltage level lower than the first voltage level, the bias enable signal may have the first voltage level during a first period and may have the second voltage level during a period excluding the first period, and the absolute value of the second voltage level may be greater than the absolute value of the first voltage level.

Further scope of applicability of the present invention will become apparent from the detailed description given hereinafter.

In some embodiments, the image sensing device may determine whether a semiconductor die is normal through an EPM test without requiring additional equipment by including a deterioration detection circuit in the image sensing device.

In some embodiments, the image sensing device may be manufactured more efficiently and at a reduced by including a deterioration detection circuit in the image sensing device.

### BRIEF DESCRIPTION OF THE DRAWINGS

FIG. 1 is a diagram illustrating a circuit configuration of an image sensing device based on an embodiment.

FIG. 2 is a diagram illustrating a wafer in a manufacturing process of an image sensing device based on an embodiment.

FIG. 3 is a diagram illustrating a die in a manufacturing process of an image sensing device based on an embodiment.

FIG. 4 is a cross-sectional view illustrating a parasitic diode of a defective pixel in an image sensing device based on an embodiment.

FIG. 5 is a waveform diagram illustrating an operation of a deterioration detection circuit of a normal pixel in an image sensing device based on an embodiment.

FIG. 6 is a circuit diagram illustrating an operation of a deterioration detection circuit of a normal pixel in an image sensing device based on an embodiment.

FIG. 7 is a waveform diagram illustrating an operation of a deterioration detection circuit of a defective pixel in an image sensing device based on an embodiment.

FIG. 8 is a circuit diagram illustrating an operation of a deterioration detection circuit of a defective pixel in an image sensing device based on an embodiment.

### DETAILED DESCRIPTION

The following description provides detailed explanation of example embodiments with reference to the accompanying drawings.

It should be understood that terms “first” and “second” are used herein to distinguish between different components and do not imply any particular order or hierarchy. For example, a “first” component may be referred to as a “second” component and vice versa. Additionally, singular forms may include the plural unless the context clearly indicates otherwise.

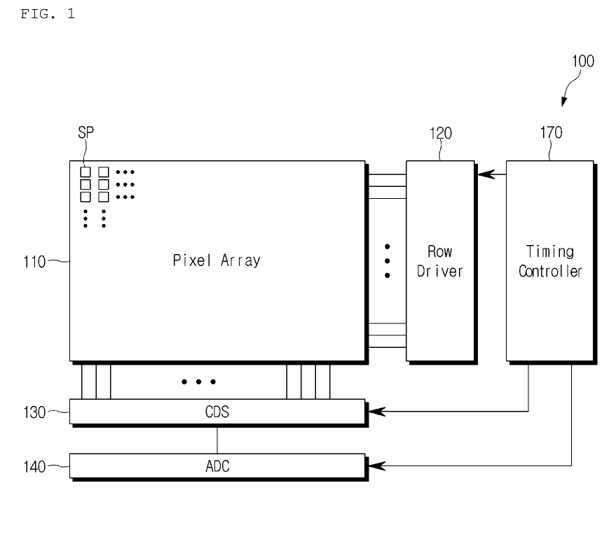

FIG. 1 is a diagram illustrating a circuit configuration of an image sensing device based on an embodiment.

Referring to FIG. 1, the image sensing device 100 may include a pixel array 110, a row driver 120, a correlated double sampler (CDS) 130, an analog-digital converter (ADC) 140, an output buffer 150, a column driver 160, and a timing controller 170.

The pixel array 110 may include a plurality of pixels PX arranged in rows and columns. For example, the image pixels may be arranged in a two-dimensional pixel array including rows and columns. For example, the image pixels may be arranged in a three-dimensional pixel array. The image pixels may convert an optical signal into an electrical signal on a pixel basis or on a pixel group basis, and the image pixels in a pixel group may share at least some internal circuits. The pixel array 110 may receive a pixel control signal including a row selection signal, a pixel reset signal, and a transmission signal from the row driver 120, and a pixel in the pixel array 110 that receives the pixel control signal may be activated and perform an operation corresponding to the row selection signal, the pixel reset signal, and the transmission signal. Each of the image pixels may generate photocharge corresponding to the intensity (or illuminance) of incident light and generate an electrical signal having a magnitude corresponding to the amount of the generated photocharge, thereby detecting incident light. Hereinafter, for convenience of explanation, image pixels may also be referred to as pixels.

The row driver 120 may activate the pixel array 110 to perform specific operations on the pixels included in the corresponding row based on the commands and control signals applied by the timing controller 170.

The correlated double sampler 130 may sequentially sample and hold the reference signal and the image signal provided to each of the column lines from the pixel array 110. That is, the correlated double sampler 130 may sample and hold the levels of the reference signal and the image signal corresponding to each of the columns of the pixel array 110. The correlated double sampler 130 may receive a control signal from the timing controller 170 and transmit the reference signal and the image signal of each of the columns to the ADC 140 as a correlated double sampling signal.

The ADC 140 may convert the correlated double sampling signal for each column output from the correlated double sampler 130 into a digital signal and output image data. For example, the ADC 140 may receive the correlated double sampling signal for each column from the correlated double sampler 130, and convert the correlated double sampling signal into a digital signal and output it.

The ADC 140 may include a plurality of column counters corresponding to each of the columns of the pixel array 110. Each column of the pixel array 110 may be electrically connected to each column counter, and the column counters may generate image data by converting a correlated double sampling signal corresponding to each of the columns into a digital signal.

The timing controller 170 may control at least one of the row driver 120, the correlated double sampler 130, or the ADC 140.

The timing controller 170 may provide clock signals required for the operation of each component of the image sensing device 100, control signals for timing control, and address signals for selecting a row or column to at least one of the row driver 120, the correlated double sampler 130, or the ADC 140. For example, the timing controller 170 may include a logic control circuit, a phase lock loop PLL circuit, a timing control circuit, and a communication interface circuit.

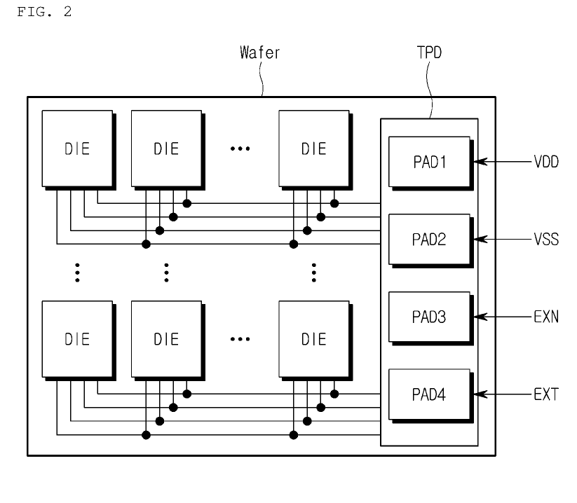

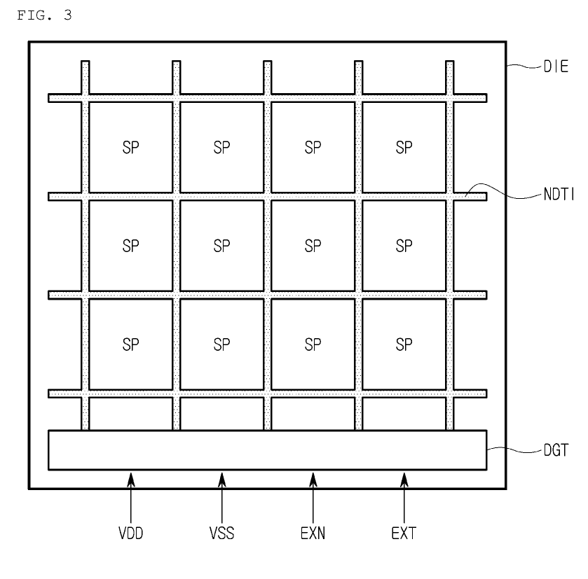

FIG. 2 is a diagram illustrating a wafer in a manufacturing process of an image sensing device based on an embodiment. FIG. 3 is a diagram illustrating a die in a manufacturing process of an image sensing device based on an embodiment.

Referring to FIGS. 2 and 3, the wafer may include a plurality of dies (semiconductor dies) (DIE). The plurality of dies (DIE) may be electrically connected to a test pad unit TPD. For example, dies (DIE) arranged in the same row may be electrically connected to the same power line, but the disclosed technology is not limited thereto. The die (DIE) may correspond to the smallest manufactured unit including circuitry. The die (DIE) may be produced as a chip including an image sensing device 100 through at least one process.

The die (DIE) may receive a voltage and a signal from the test pad section TPD. The test pad unit TPD may include first to fourth pad units PAD1, PAD2, PAD3, and PAD4. The first to fourth pad units PAD1, PAD2, PAD3, and PAD4 may receive a voltage or a signal from the outside and transmit it to the plurality of dies (DIE). The first pad unit PAD1 may receive a power supply voltage VDD and transmit it to the die (DIE). The second pad unit PAD2 may receive a low-potential voltage VSS and transmit it to the die (DIE). The third pad unit PAD3 may receive a bias enable signal EXN and transmit it to the die (DIE). The fourth pad unit PAD4 may receive a bias voltage EXT and transmit it to the die (DIE).

The die (DIE) may include a plurality of pixels SP. The pixel SP may include at least one light detection area and a circuit area overlapping the light detection area. The light detection area may include a light detector, and the circuit area may include a pixel circuit electrically connected to the light detector. Each of the plurality of pixels SP is separated by a bias conductive structure NDTI and may be surrounded by the bias conductive structure NDTI.

In some embodiments, the bias conductive structure NDTI may have a lattice structure, but the disclosed technology is not limited thereto. The bias conductive structure NDTI may include doped silicon or doped semiconductor materials. The bias conductive structure NDTI of the die (DIE) may be integrally formed and electrically connected to the deterioration detection circuit DGT. For example, the deterioration detection circuit DGT may be disposed on the lower side of the die (DIE), but the embodiments are not limited thereto. For another example, the die (DIE) may include at least one deterioration detection circuit DGT, and the at least one deterioration detection circuit DGT may be disposed on at least one of the upper side, the lower side, the left side, or the right side of the die (DIE). For another example, the deterioration detection circuit DGT may overlap a plurality of pixels SP and may be disposed on the lower side of the pixels SP.

The deterioration detection circuit DGT may receive a power supply voltage VDD, a low-potential voltage VSS, a bias enable signal EXN, and a bias voltage EXT from the test pad unit TPD. The deterioration detection circuit DGT may detect whether the die (DIE) is deteriorated by applying the bias voltage EXT to the bias conductive structure NDTI. If the die (DIE) is not deteriorated, a parasitic diode may not be generated in the pixel SP. If the die (DIE) is deteriorated, the deterioration detection circuit DGT may detect that the pixel SP and the bias conductive structure NDTI are short-circuited by the parasitic diode generated in the pixel SP. The parasitic diode in the pixel SP may be formed by particles generated during the manufacturing process, but the cause of the parasitic diode generation is not limited thereto.

The manufacturing process of the image sensing device 100 may determine whether the die (DIE) is normal through an electrical parameter monitoring (EPM) test. In the EPM test, the deterioration detection circuit DGT may detect a short between the pixel SP and the bias conductive structure NDTI by receiving a power supply voltage VDD, a low-potential voltage VSS, a bias enable signal EXN, and a bias voltage (EXT). Upon completion of the EPM test, at least one test including a wafer test can be performed to select a defective die (DIE), and a normal die (DIE) can be produced as a chip including the image sensing device 100 through at least one process.

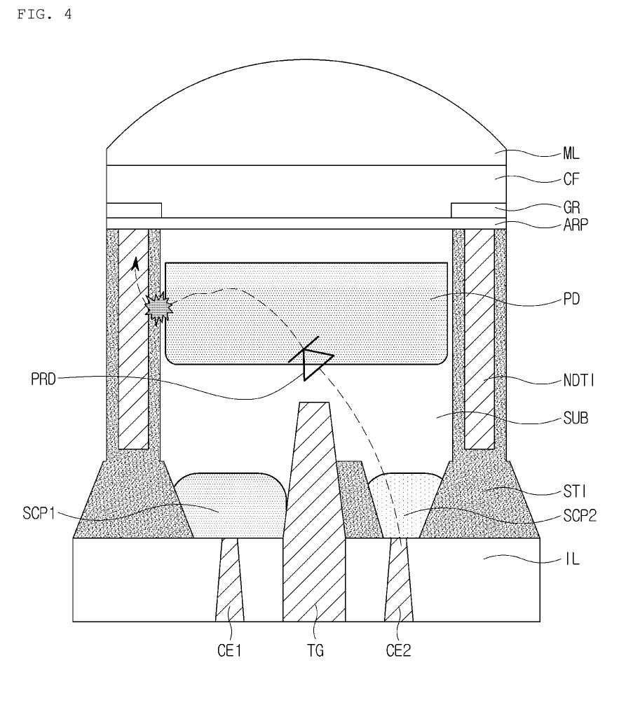

FIG. 4 is a cross-sectional view illustrating a parasitic diode of a defective pixel in an image sensing device based on an embodiment.

Referring to FIG. 4, the pixel SP may include an insulating layer IL, a substrate SUB, an anti-reflection layer ARP, a grid portion GR, a color filter CF, and a micro lens ML.

The insulating layer IL may include a plurality of grooves. The plurality of grooves may completely penetrate from the lower surface to the upper surface of the insulating layer IL. Each of the transfer gate electrode TG, the first connection electrode CE1, and the second connection electrode CE2 may be inserted into each of the grooves of the insulating layer IL.

The substrate SUB may be disposed on the insulating layer IL. The substrate SUB may include silicon (Si) and may be a region doped with a P-type impurity. The substrate SUB may include a photodetector PD, a first semiconductor region SCP1, and a second semiconductor region SCP2. The photodetector PD may be disposed within the substrate SUB and may be doped with an N-type impurity.

The first semiconductor region SCP1 may be arranged on the insulating layer IL and electrically connected to the first connection electrode CE1. The first semiconductor region SCP1 may be arranged in a well shape on the lower surface of the substrate SUB. The first semiconductor region SCP1 may be a region doped with an N-type impurity. For example, the first semiconductor region SCP1 may be a floating diffusion region FD of the pixel SP.

The second semiconductor region SCP2 may be arranged on the insulating layer IL and electrically connected to the second connection electrode CE2. The second semiconductor region SCP2 may be arranged in a well shape on the lower surface of the substrate SUB. The second semiconductor region SCP2 may be a region doped with a P-type impurity. For example, the second semiconductor region SCP2 may receive a low-voltage voltage VSS through the second connection electrode CE2.

The transfer gate electrode TG may be inserted into the groove of the insulating layer IL and may penetrate to a lower portion of the substrate SUB. The transfer gate electrode TG may be the gate electrode of the transfer transistor TT of the pixel SP. The transfer gate electrode TG may be insulated from the second semiconductor region SCP2. The transfer gate electrode TG may be separated from the photodetector PD. For another example, the transfer gate electrode TG may be inserted into a part of the photodetector PD.

The separation structure STI may completely penetrate the substrate SUB to separate the plurality of pixels SP and insulate the plurality of pixels SP. The separation structure STI may have a lattice structure, such as the bias conductive structure NDTI of FIG. 3. The separation structure STI may surround each of the plurality of pixels SP. For example, the separation structure STI may be formed by a deep trench isolation (DTI) process. The separation structure STI may include an insulating material. For example, the separation structure STI may include at least one of hafnium oxide (HfOx), silicon oxide (SiOx), or tantalum oxide (TaOx), but the disclosed technology is not limited thereto.

The bias conductive structure NDTI may be disposed inside and surrounded by the separation structure STI. The bias conductive structure NDTI may include a conductive material. The bias conductive structure NDTI may be formed by injecting polysilicon into the separation structure STI, but the disclosed technology is not limited thereto. The bias conductive structure NDTI may be electrically insulated from the substrate SUB and the photodetector PD by the separation structure STI. The bias conductive structure NDTI may receive a low-potential voltage or a negative bias voltage to control electrons that are generated at the interface of the separation structure STI by dangling bonding. For example, when the bias conductive structure NDTI receives a negative bias voltage, holes may be generated at the interface of the separation structure STI, and the holes may combine with electrons via dangling bonding recombination.

An anti-reflection layer ARP may be disposed on the substrate SUB. The anti-reflection layer ARP may include at least one insulating material. For example, the anti-reflection layer ARP may include at least one of hafnium oxide (HfOx), silicon oxide (SiOx), or tantalum oxide (TaOx), but the disclosed technology is not limited thereto. The anti-reflection layer ARP may not reflect light passing through the color filter CF and may allow light to be incident on the substrate SUB.

The grid portion GR may be disposed on the anti-reflection layer ARP and may overlap with the separation structure STI and the bias conductive structure NDTI. The grid portion GR may absorb or reflect incident light, thereby preventing light mixing between adjacent pixels SP. The grid portion GR may include a light absorbing material or a low-refractive layer. For example, when the grid portion GR includes a light absorbing material, it may include a metal material. Here, the metal material may include tungsten (W), but the embodiments are not limited thereto. When the grid portion GR includes a low-refractive layer, the grid portion GR may include a low-refractive insulating material or an air structure.

A color filter CF may be disposed on the anti-reflection layer ARP and the grid portion GR. The color filter CF may include a red color filter, a green color filter, or a blue color filter. Optionally, the color filter CF may further include a white color filter.

The micro lens ML may be placed on the color filter CF. The micro lens ML may focus light incident from the outside onto the photodetector PD. The micro lens ML may have a shape of a convex lens with a convex upper portion, and may be formed of a material having a large refractive index difference compared to the external air (Air). For example, the refractive index of the micro lens ML may be about 1.5 to about 1.7, but the disclosed technology is not limited thereto.

A defective pixel SP or a defective die DIE may include a parasitic diode PRD caused, for example, by a defect in the separation structure STI. In a normal pixel SP, the bias conductive structure NDTI may be electrically insulated from the substrate SUB and the photodetector PD by the separation structure STI, but in a defective pixel SP, a short circuit between the bias conductive structure NDTI , the substrate SUB, and the photodetector PD, may form a parasitic diode PRD. A parasitic diode PRD may be formed by particles generated during the manufacturing process, although other causes are possible. Therefore, when a negative bias voltage is applied to the bias conductive structure NDTI in a defective pixel SP, a leakage current may flow through the second connection electrode CE2, the second semiconductor region SCP2, the substrate SUB, the photodetector PD, and the bias conductive structure NDTI due to the electric potential difference between the low- voltage VSS and the negative bias voltage.

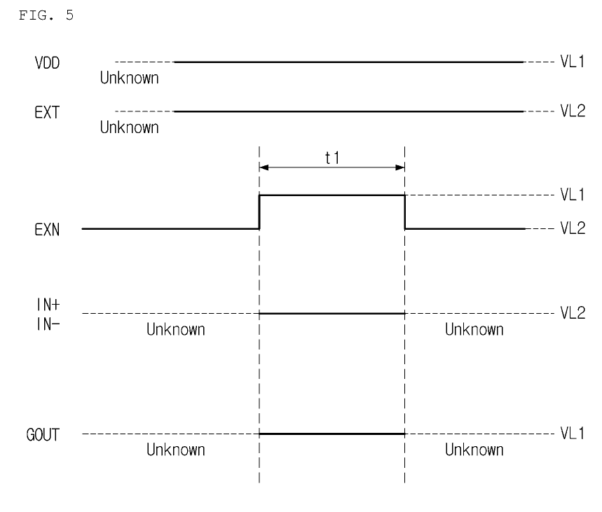

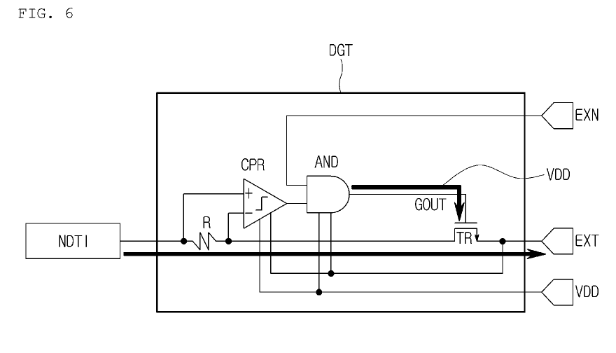

FIG. 5 is a waveform diagram illustrating an operation of a deterioration detection circuit of a normal pixel in an image sensing device based on an embodiment. FIG. 6 is a circuit diagram illustrating an operation of a deterioration detection circuit of a normal pixel in an image sensing device based on an embodiment.

Referring to FIGS. 5 and 6, the deterioration detection circuit DGT may detect the leakage current flowing in the bias conductive structure NDTI. If the leakage current does not flow in the bias conductive structure NDTI, the switching element TR may be turned on and the voltage difference between the two ends of the resistor portion R may not occur. If the leakage current flows in the bias conductive structure NDTI, the switching element TR may be turned off and the voltage difference between the two ends of the resistor portion R may occur. The deterioration detection circuit DGT may include the resistor portion R, a comparator CPR, a logic gate such as an AND gate (AND), and the switching element TR.

One end of the resistor portion R may be connected to the bias conductive structure NDTI. As shown in FIG. 3, the bias conductive structure NDTI of the die (DIE) may be integrally formed with and connected to one end of the resistor portion R. One end of the resistor portion R may be connected to the first input terminal (+) of the comparator CPR.

The other end of the resistor portion R may be connected to the second input terminal (-) of the comparator CPR. When a leakage current flows in the bias conductive structure NDTI, a voltage drop may occur in the resistor portion R. Therefore, when a leakage current flows in the bias conductive structure NDTI, a potential (electric potential) difference between the first and second input terminals (+, -) of the comparator CPR may occur.

The comparator CPR may determine an output voltage by comparing the voltages of the first and second input terminals (+, -). The comparator CPR may operate in response to receiving a power supply voltage VDD and a bias voltage EXT. When the potential difference between the first and second input terminals (+, -) is less than or equal to a reference voltage, the comparator CPR may output the power supply voltage VDD. The comparator CPR may output a bias voltage EXT when the potential difference between the first and second input terminals (+, -) is greater than or equal to the reference voltage.

The logic gate such as AND gate (AND) may determine an output voltage by comparing the bias enable signal EXN and the output of the comparator CPR. The AND gate (AND) may operate by receiving a power supply voltage VDD and a bias voltage EXT. The AND gate (AND) may output the power supply voltage VDD when the outputs of the bias enable signal EXN and the comparator CPR are the same. The AND gate (AND) may output the bias voltage EXT when the outputs of the bias enable signal EXN and the comparator CPR are different.

The switching element TR may include a transistor. The switching element TR may be turned on or off based on the output signal GOUT of the AND gate (AND). The switching element TR may be turned on when the gate-source voltage is greater than the threshold voltage. Therefore, the switching element TR may be turned on when the AND gate (AND) outputs the power voltage VDD, and may be turned off when the AND gate (AND) outputs the bias voltage EXT. Therefore, the deterioration detection circuit DGT may turn on the switching element TR because no leakage current flows to the bias conductive structure NDTI in the case of a normal pixel SP. The deterioration detection circuit DGT may turn off the switching element TR because a leakage current flows to the bias conductive structure NDTI in the case of a defective pixel SP.

The manufacturing process of the image sensing device 100 may determine whether the die (DIE) is normal through an (electrical parameter monitoring (EPM) test. In the EPM test, the deterioration detection circuit DGT may detect a short circuit between the pixel SP and the bias conductive structure NDTI in response to receiving the power supply voltage VDD, the low-potential voltage VSS, the bias enable signal EXN, and the bias voltage EXT. Upon completion of the EPM test, at least one test including a wafer test may be performed to select a defective die (DIE), and a normal die (DIE) may be produced as a chip including the image sensing device 100 through at least one process.

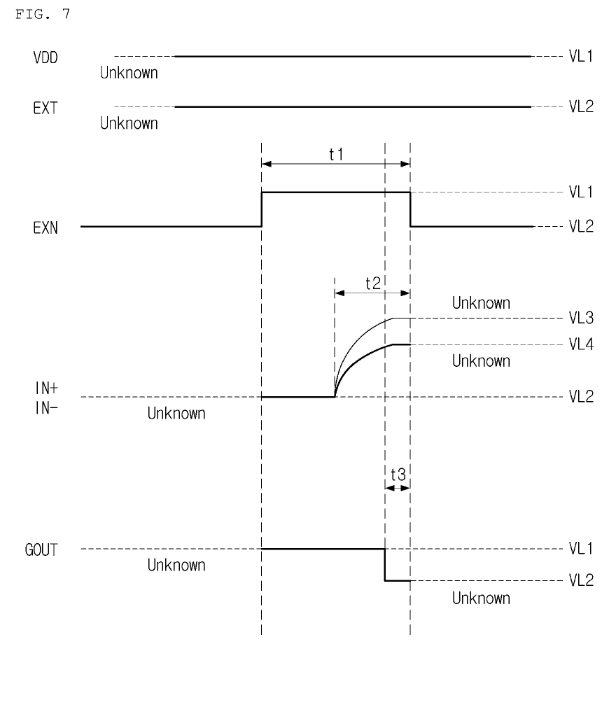

In FIG. 7, the power supply voltage VDD may have a first voltage level VL1, and the bias voltage EXT may have a second voltage level VL2. Here, the first voltage level VL1 is a positive voltage, the second voltage level VL2 is a negative voltage, and the absolute value of the second voltage level VL2 may be greater than the absolute value of the first voltage level VL1. For example, the absolute value of the second voltage level VL2 may be at least twice the absolute value of the first voltage level VL1, but the disclosed technology is not limited thereto. Accordingly, the bias voltage EXT may correspond to a negative bias voltage.

The bias enable signal EXN may have the first voltage level VL1 during the first period t1. The bias enable signal EXN may have a second voltage level VL2 before the first period t1 and after the first period t1.

The normal pixel SP may be electrically insulated from the substrate SUB and the photodetector PD by the separation structure STI through the bias conductive structure NDTI, and no leakage current may flow through the bias conductive structure NDTI. Therefore, no voltage drop may occur in the resistor portion R, and the first input terminal (IN+) and the second input terminal (IN-) of the comparator CPR may have the same voltage. The first input terminal (IN+) and the second input terminal (IN-) of the comparator CPR may have the second voltage level VL2 during the first period t1.

The comparator CPR may output the power supply voltage VDD when the potential difference between the first and second input terminals (+, -) is less than or equal to the reference voltage. The AND gate (AND) may output the power supply voltage VDD when the output of the bias enable signal EXN and the comparator CPR are the same. During the first period t1, the bias enable signal EXN has the first voltage level VL1 and the comparator CPR outputs the power supply voltage VDD having the first voltage level VL1, so the AND gate (AND) may output the power supply voltage VDD.

The switching element TR may be turned on based on the output signal GOUT of the AND gate (AND). Therefore, the deterioration detection circuit DGT may turn on the switching element TR because no leakage current flows to the bias conductive structure NDTI in the case of a normal pixel SP.

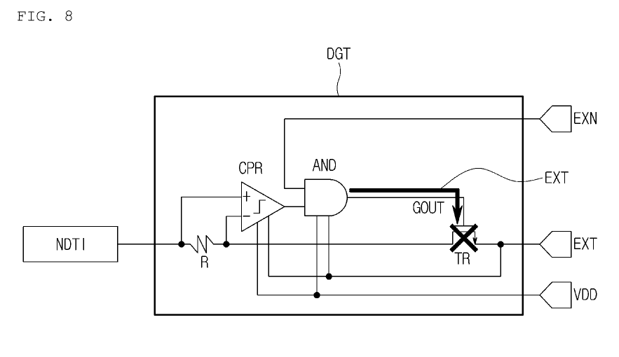

FIG. 7 is a waveform diagram illustrating an operation of a deterioration detection circuit of a defective pixel in an image sensing device based on an embodiment. FIG. 8 is a circuit diagram illustrating an operation of a deterioration detection circuit of a defective pixel in an image sensing device based on an embodiment. Hereinafter, the configurations described above in FIGS. 5 and 6 will be briefly described or omitted.

Referring to FIGS. 7 and 8, the bias conductive structure NDTI of the defective pixel SP may be short-circuited with the substrate SUB and the photodetector PD, forming a parasitic diode PRD. When a negative bias voltage is applied to the bias conductive structure NDTI in the defective pixel SP, a leakage current may flow through the second connection electrode CE2, the second semiconductor region SCP2, the substrate SUB, the photodetector PD, and the bias conductive structure NDTI due to the potential difference between the low-potential voltage VSS and the bias voltage EXT. Therefore, a voltage drop may occur in the resistor portion R, and the first input terminal (IN+) and the second input terminal (IN-) of the comparator CPR may have different voltages. At the beginning of the first period t1, the first input terminal (IN+) and the second input terminal (IN-) of the comparator CPR may have a second voltage level VL2, and the potential difference between the first and second input terminals (IN+, IN-) may correspond to 0.

From the second period (t2), the potential difference between the first and second input terminals (IN+, IN-) may begin to increase. The second period (t2) may last from the middle of the first period (t1) to the end point of the first period (t1). The potential difference between the first and second input terminals (IN+, IN-) may gradually increase and become higher than the reference voltage when the third period t3 begins. The third period t3 may last from the latter half of the second period t2 to the end point of the second period t2.

During the third period t3, the first input terminal (IN+) of the comparator CPR may have a third voltage level VL3 and the second input terminal (IN-) may have a fourth voltage level VL4. The third voltage level VL3 may be lower than the first voltage level VL1 and higher than the fourth voltage level VL4. The fourth voltage level VL4 may be higher than the second voltage level VL2.

Before the third period t3, since the potential difference between the first and second input terminals (+, -) is lower than or equal to the reference voltage, the comparator CPR may output the power supply voltage VDD.

During the third period t3, since the potential difference between the first and second input terminals (+, -) is higher than or equal to the reference voltage, the comparator CPR may output the bias voltage EXT. The AND gate (AND) may output a bias voltage EXT when the outputs of the bias enable signal EXN and the comparator CPR are different. During the third period t3, the bias enable signal EXN has a first voltage level VL1 and the comparator CPR outputs a bias voltage EXT having a second voltage level VL2, so that the AND gate (AND) may output a bias voltage EXT.

The switching element TR may be turned off based on the output signal GOUT of the AND gate (AND). Therefore, the deterioration detection circuit DGT may turn off the switching element TR because a leakage current flows to the bias conductive structure NDTI in the case of a defective pixel SP.

The manufacturing process of the image sensing device 100 may determine whether the die (DIE) is normal through an EPM test without requiring additional equipment. Upon completion of the EPM test, at least one test including a wafer test may be performed to select a defective die (DIE), and a normal die (DIE) may be produced as a chip including an image sensing device 100 through at least one process. Accordingly, since the image sensing device 100 includes a deterioration detection circuit DGT, the manufacturing process may be performed more efficiently and the manufacturing cost may be reduced.

Only a few implementations and examples of the disclosed technology are described and other implementations, enhancements and variations can be made based on what is described and illustrated in this patent document.

What is claimed is:

1. An image sensing device comprising:
a plurality of pixels, each of the plurality of pixels including a photodetector;
a separation structure surrounding each of the plurality of pixels to separate each pixel from adjacent pixels;
a bias conductive structure disposed inside the separation structure and insulated from the photodetector by the separation structure; and
a deterioration detection circuit electrically connected to the bias conductive structure and configured to detect a leakage current flowing in the bias conductive structure in response to a negative bias voltage applied to the deterioration detection circuit,
wherein the deterioration detection circuit comprises,
a resistor portion including one end electrically connected to the bias conductive structure; and
a switching element configured to turn off in response to a voltage drop occurring across the resistor portion.

2. The image sensing device of claim 1, wherein the deterioration detection circuit further comprises:
a first input terminal electrically connected to one end of the resistor portion; and
a comparator electrically connected to another end of the resistor portion.

3. The image sensing device of claim 2, wherein the deterioration detection circuit further comprises:
a logic gate configured to compare an output of the comparator and a bias enable signal to determine an output voltage of the logic gate.

4. The image sensing device of claim 3, wherein the bias enable signal has a first voltage level during a first period, and a second voltage level lower than the first voltage level during a period other than the first period, and wherein an absolute value of the second voltage level is greater than an absolute value of the first voltage level.

5. The image sensing device of claim 4, wherein the comparator and the logic gate operate in response to receiving a power supply voltage having the first voltage level and a bias voltage having the second voltage level.

6. The image sensing device of claim 4, wherein, in response to an absence of a short-circuit between the bias conductive structure and the photodetector during the first period, the resistor portion configured to have no voltage drop.

7. The image sensing device of claim 6, wherein, in response to the absence of a short-circuit between the bias conductive structure and the photodetector during the first period, the comparator outputs the first voltage level, and the logic gate outputs the first voltage level.

8. The image sensing device of claim 7, wherein, in response to the absence of a short-circuit between the bias conductive structure and the photodetector during the first period, the switching element is turned on in response to receiving a power supply voltage having the first voltage level.

9. The image sensing device of claim 4, wherein, in response to a presence of a short-circuit between the bias conductive structure and the photodetector during the first period, the resistor portion configured to have a voltage drop.

10. The image sensing device of claim 9, wherein, in response to the presence of a short-circuit between the bias conductive structure and the photodetector during the first period, the comparator outputs the second voltage level, and the logic gate outputs the second voltage level.

11. The image sensing device of claim 10, wherein, in response to the presence of a short-circuit between the bias conductive structure and the photodetector during the first period, the switching element is turned off in response to receiving a bias voltage having the second voltage level.

12. The image sensing device of claim 1, wherein the bias conductive structure has a lattice structure and is integrally formed and electrically connected to the deterioration detection circuit.

13. The image sensing device of claim 1, wherein each of the plurality of pixels further comprises,
an insulating layer including at least one groove;
a substrate disposed on the insulating layer;
a semiconductor region disposed on a lower surface of the substrate; and
a connecting electrode inserted into the at least one groove and connected to the semiconductor region.

14. The image sensing device of claim 13, wherein, in response to a presence of a short-circuit between the bias conductive structure and the photodetector, the deterioration detection circuit receives a leakage current through the connecting electrode, the semiconductor region, the substrate, the photodetector, and the bias conductive structure.

15. An image sensing device comprising:
a plurality of pixels, each of the plurality of pixels including a photodetector;
a separation structure surrounding each of the plurality of pixels to separate each pixel from adjacent pixels;
a bias conductive structure disposed inside the separation structure and insulated from the photodetector by the separation structure; and
a deterioration detection circuit electrically connected to the bias conductive structure and configured to detect a leakage current flowing in the bias conductive structure in response to receiving a power supply voltage, a bias voltage, and a bias enable signal,
wherein the power supply voltage has a first voltage level, the bias voltage has a second voltage level lower than the first voltage level, the bias enable signal has the first voltage level during a first period and has the second voltage level during a period excluding the first period, and an absolute value of the second voltage level is greater than an absolute value of the first voltage level.

16. The image sensing device of claim 15, wherein the deterioration detection circuit comprises,
a resistor portion including one end electrically connected to the bias conductive structure;
a first input terminal electrically connected to one end of the resistor portion, and a comparator electrically connected to another end of the resistor portion;
a logic gate configured to compare an output of the comparator and a bias enable signal to determine an output voltage of the logic gate; and
a switching element configured to be turned on or off based on the output of the logic gate.

17. The image sensing device of claim 16, wherein, in response to an absence of a short-circuit between the bias conductive structure and the photodetector during the first period, the comparator outputs the first voltage level, and the logic gate outputs the first voltage level.

18. The image sensing device of claim 17, wherein, in response to the absence of a short-circuit between the bias conductive structure and the photodetector during the first period, the switching element is turned on in response to receiving a power supply voltage having the first voltage level.

19. The image sensing device of claim 16, wherein, in response to a presence of a short-circuit between the bias conductive structure and the photodetector during the first period, the comparator outputs the second voltage level, and the logic gate outputs the second voltage level.

20. The image sensing device of claim 19, wherein, in response to a presence of a short-circuit between the bias conductive structure and the photodetector during the first period, the switching element is turned off by receiving a bias voltage having the second voltage level.
